(19) United States
(12) Patent Application Publication
(10) Pub. No.: US 2008/0309840 A1
(43) Pub. Date: Dec. 18, 2008

(54) PIXEL ELEMENT AND LIQUID CRYSTAL DISPLAY

(75) Inventors: Cheng-Chi Yen, Tainan County (TW); Chien-Jung Chen, Tainan County (TW); Yung-Yuan Ho, Tainan County (TW); Mao-Jung Chung, Tainan County (TW); Jiunn-Yau Huang, Tainan County (TW)

Correspondence Address: J C PATENTS, INC., 4 VENTURE, SUITE 250, IRVINE, CA, 92618, US

(73) Assignees: HIMAX TECHNOLOGIES INC., Tainan County (TW); HIMAX DISPLAY, INC., Tainan County (TW)

(21) Appl. No.: 11/763,877

(22) Filed: Jun. 15, 2007

(51) Int. Cl. G02F 1/136

(52) U.S. Cl. 349/48

(57) ABSTRACT

A pixel element and a liquid crystal display with discharge function are disclosed. In each of the pixel elements of the liquid crystal display, a transistor is disposed between the common electrode and the pixel electrode. The transistor will be turned on by a discharge signal sent from the master control unit of the liquid crystal display when the liquid crystal display is turned on or turned off, so as to provide the same common voltage to both the common electrode and the pixel electrode. Therefore, the positive and negative charges accumulated in the common electrode and the pixel electrode can be removed and the liquid crystal display is well protected.

### BACKGROUND OF THE INVENTION

1. Field of the Invention

The present invention relates to a liquid crystal display, in particular, to a pixel element of the liquid crystal display, which is effective in panel discharging.

2. Description of Related Art

The alignment of LC (liquid crystal) is decided by an electric field applied to them. The LC is allocated within each pixel element of a liquid crystal display between a common electrode and a pixel electrode. When a DC component exists between the common electrode and the pixel electrode due to non-ideal LCD characteristics, the potential difference between the two electrodes is likely to attract positive and negative charges on the two electrodes and applying an electric field on the LC even after turned off, as shown in FIG. 1(a).

The positive and negative charges may shorten the life time of the liquid crystal display, and establish image persistence on the display panel.

To avoid the drawback, panel discharging is desired to remove the positive and negative charges on the two electrodes. As an example, the same voltages may be applied to both the common electrode and the pixel electrode, so that the positive and negative charges will no longer stay on the electrodes, as shown in FIG. 1(b).

As an example, the application of the same voltages to both the common electrode and the pixel electrode may be implemented by providing a common voltage to the pixel electrode through the source driver of the liquid crystal display.

### SUMMARY OF THE INVENTION

Accordingly, an object of the present invention is directed to the pixel elements and the liquid crystal display with discharge function to protect the LC for longer life and erase the image shown on the display panel after the liquid crystal display is turned off.

The present invention is directed to a pixel element. The pixel element of the present invention comprises a LC, a capacitor, a first transistor, and a second transistor. The LC allocated between a pixel electrode and a common electrode receiving a common voltage. The capacitor is connected between the pixel electrode and the common electrode. The first transistor has its gate receiving a scan voltage from the gate driver and has its source and drain respectively receiving a data voltage from the source driver and connecting the pixel electrode. The second transistor has its gate receiving a discharge signal from a master control unit of the liquid crystal display and has its source and drain connected between the pixel electrode and the common electrode. The first and the second transistor can be NMOS or PMOS transistors.

The present invention is directed to a liquid crystal display. The liquid crystal display of the present invention comprises a gate driver, a source driver, and a display panel that includes a plurality of pixel elements. The gate driver provides a scan voltage. The source drive provides a data voltage. Each of the pixel elements comprises a LC, a capacitor, a first transistor, and a second transistor. The LC allocated between a pixel electrode and a common electrode receiving a common voltage. The capacitor is connected between the pixel electrode and the common electrode. The first transistor has its gate receiving a scan voltage and has its source and drain respectively receiving a data voltage and connecting the pixel electrode. The second transistor has its gate receiving a discharge signal from a master control unit of the liquid crystal display and has its source and drain connected between the pixel electrode and the common electrode. The first and the second transistor can be NMOS or PMOS transistors.

The liquid crystal display according to an embodiment of the present invention, wherein the liquid crystal display further comprises a switch circuit disposed between the source driver and the display panel for disconnecting the source driver from the display panel when the liquid crystal display is shut down.

The liquid crystal display according to an embodiment of the present invention, wherein the liquid crystal display can be a liquid crystal on silicon (LCOS) display.

By the present invention, a common voltage is applied to both the common and pixel electrodes in the liquid crystal display panel when the display is turned on or turned off. With the same voltage on both the common and pixel electrodes, the positive and negative charges accumulated in the common electrode and the pixel electrode can be removed, so that the image shown on the display panel after the liquid crystal display is turned off is erased and the liquid crystal display is well protected.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1(a) is a schematic diagram showing the positive and negative charges distributed on the common electrode and the pixel electrode when a DC component exists between the two electrodes due to non-ideal LCD characteristics.

FIG. 1(b) is a schematic diagram showing the positive and negative charges distributed on the common electrode and the pixel electrode after panel discharging.

FIG. 2 is a schematic diagram showing a pixel element according to one embodiment of the present invention.

FIG. 3 is a schematic diagram showing a liquid crystal display according to one embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 2 is a circuit diagram illustrating a pixel element 200 according to one embodiment of the present invention. Referring to FIG. 2, the pixel element 200 of the present invention comprises LC allocated between a pixel electrode and a common electrode, a capacitor Cs, a first transistor Q1, and a second transistor Q2. The capacitor Cs is connected between the pixel electrode and the common electrode. The first transistor Q1 has its gate receiving a scan voltage from the scan line SL and has its source and drain respectively receiving a data voltage from the data line DL and connecting the pixel electrode. The second transistor Q2 has its gate receiving a discharge signal and has its source and drain connected between the pixel electrode and the common electrode. The first transistor Q1 and the second transistor Q2 can be NMOS or PMOS transistors.

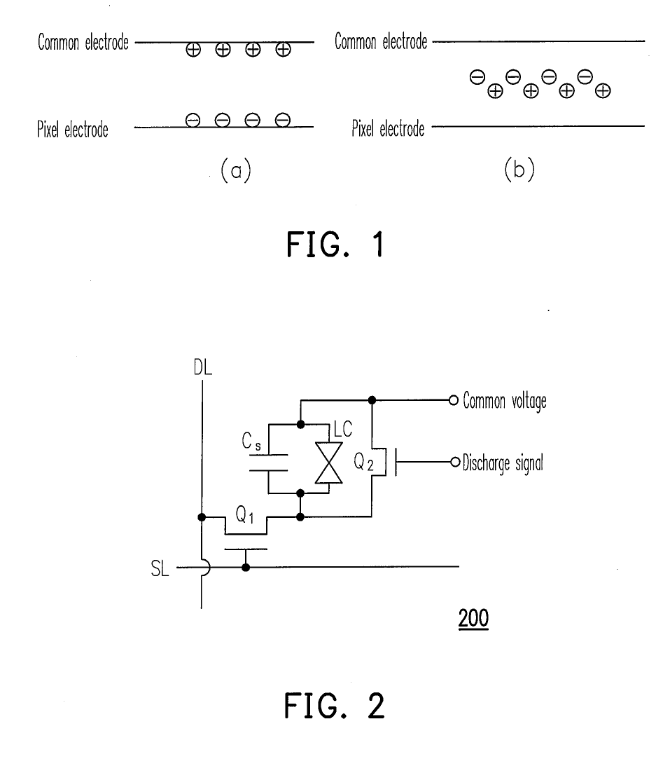

When the discharge signal is activated to turn on the second transistor Q2, the common voltage is applied to both the common electrode and the pixel electrode, so that the positive and the negative charges on the two electrodes will no longer stay on the two electrodes, as shown in FIG. 1(b).

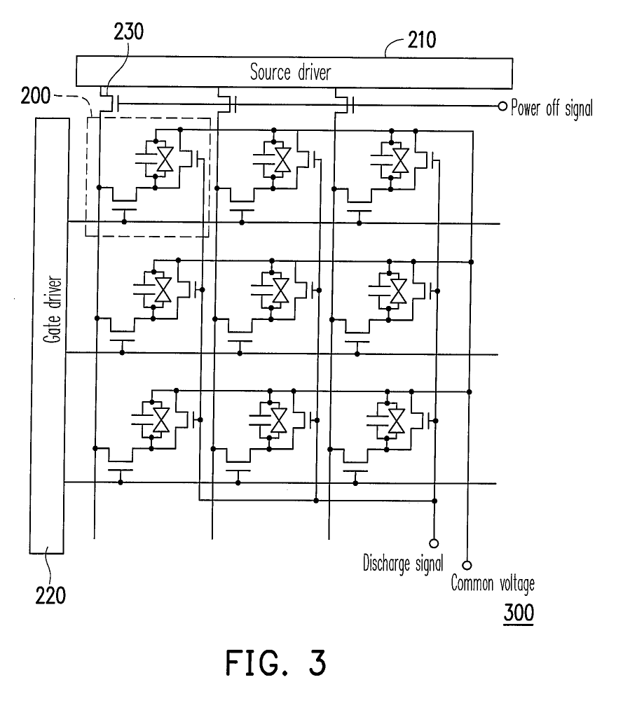

FIG. 3 is a circuit diagram of a liquid crystal display 300 according to one embodiment of the present invention. Referring to both FIG. 2 and FIG. 3, the liquid crystal display 300 of the present invention comprises a gate driver 220, a source driver 210, and a display panel that includes a matrix of pixel elements 200. The gate driver 220 provides the scan voltage on each of the scan lines SL. The source drive 210 provides the data voltage on each of the data lines DL. Each of the pixel elements 200 comprises LC allocated between a common electrode and a pixel electrode, a capacitor Cs, a first transistor Q1, and a second transistor Q2. The discharge signal is provided by a master control unit (not shown) to each of the pixel elements 200, at the gate of the second transistor Q2, and activated when the panel discharging of the liquid crystal display 300 is to be performed. The common voltage is provided to the liquid crystal display 300 and coupled to each of the common electrodes. The capacitor Cs is connected between the pixel electrode and the common electrode. The first transistor Q1 has its gate receiving a scan voltage and has its source and drain respectively receiving a data voltage and connecting the pixel electrode. The second transistor Q2 has its gate receiving a discharge signal and has its source and drain connected between the pixel electrode and the common electrode. The first transistor Q1 and the second transistor Q2 can be NMOS or PMOS transistors.

When the panel discharging of the liquid crystal display 300 is to be performed, for example, when turned on or turned off, the discharge signal will be activated to turn on the second transistor Q2, playing the role as a switch to change the conduction state between its source and drain, so that the same common voltage will be applied to both the common electrode and the pixel electrode and the positive and negative charges on the common electrode and the pixel electrode may be removed.

The liquid crystal display 300 further comprises a switch circuit 230 located between the source driver 210 and each of the data lines DL within the display panel in order to connect and disconnect the source driver 210 to each of the data lines when turned on and turned off. For example, a power off signal is provided to the switch circuit 230 of the liquid crystal display 300, switching on and switching off the switch circuit 230 when turned on and turned off. Additionally, the liquid crystal display 300 may be a liquid crystal on silicon (LCOS) display, but not limited to it.

Based on the above, a pixel element effective in panel discharging and a liquid crystal display enclosing the pixel element are disclosed. In such a pixel element, a transistor is additionally inserted between the common electrode and the pixel electrode to perform the panel discharging based on a discharge signal. With the present invention, system designers may use only one discharge signal to complete panel discharging, instead of providing the common voltage to each of the pixel electrodes through each of the data lines. Further, with the present invention, the design complexity of the liquid crystal display may be also lowered.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A pixel element (200) for a liquid crystal display (LCD), comprising:
LC allocated between a pixel electrode and a common electrode receiving a common voltage;
a capacitor (Cs) connected between the pixel electrode and the common electrode;
a first transistor (Q1) having its gate receiving a scan voltage and having its source and drain respectively receiving a data voltage and connecting the pixel electrode; and
a second transistor (Q2) having its gate receiving a discharge signal and having its source and drain connected between the pixel electrode and the common electrode.

2. The pixel element as recited in claim 1, the first transistor (Q1) and the second transistor (Q2) are NMOS or PMOS transistors.

3. A liquid crystal display (300), comprising:
a gate driver (210) providing a scan voltage;
a source driver (220) providing a data voltage; and
a display panel including a matrix of pixel elements (200), each of the pixel elements (200) comprising:
LC allocated between a pixel electrode and a common electrode
receiving a common voltage;
a capacitor (Cs) connected between the pixel electrode and the common electrode;
a first transistor (Q1) having its gate receiving the scan voltage and having its source and drain respectively receiving the data voltage and connecting the pixel electrode; and
a second transistor (Q2) having its gate receiving a discharge signal and having its source and drain connected between the pixel electrode and the common electrode.

4. The liquid crystal display as recited in claim 3, further comprising a switch circuit (230) located between the source driver (210) and the display panel in order to connect and disconnect the source driver (210) to the display panel when turned on and turned off.

5. The liquid crystal display as recited in claim 3, the first transistor (Q1) and the second transistor (Q2) are NMOS or PMOS transistors.

6. The liquid crystal display as recited in claim 3, the discharge signal is activated when the panel discharging of the liquid crystal display (300) is to be performed.

7. The liquid crystal display as recited in claim 3, the discharge signal is activated when the liquid crystal display (300) is turned on or turned off.

8. The liquid crystal display as recited in claim 3, the discharge signal is provided by a master control unit of the liquid crystal display (300).

9. The liquid crystal display as recited in claim 3, the liquid crystal display (300) is a liquid crystal on silicon (LCOS) display.
